(19) United States
(12) Patent Application Publication
(10) Pub. No.: US 2015/0362109 A1
(43) Pub. Date: Dec. 17, 2015

(54) TUBE FITTING CONNECTION SYSTEM AND METHOD

(71) Applicant: Buchanan Consulting LLC, Lopez Island, WA (US)

(72) Inventor: Bradley H. BUCHANAN, Lopez Island, WA (US)

(21) Appl. No.: 14/303,467

(22) Filed: Jun. 12, 2014

(51) Int. Cl. F16L 33/22; F16L 33/30; F16L 21/00

(52) U.S. Cl. CPC F16L 33/225; F16L 21/00; F16L 33/30

(57) ABSTRACT

A tube connection assembly having an elastomeric tube defining a fluid channel therethrough, and a retention sleeve, composed of a cross-linked PEX material having memory retention properties, disposed around the distal portion of tube device. Prior to partial assembly, the retention sleeve is expanded about 15% to about 50% from an unexpanded natural condition to an expanded condition, enabling placement onto the tube device. The tube distal portion and disposed retention sleeve can then be connected to a barbed male portion of a connector fitting, where the sleeve will radially retract back toward the natural condition, generating significant, radially uniform, hoop forces around the tube distal portion for fluid tight mounting to the connector fitting.

### FIELD OF THE INVENTION

The present invention relates to tube connection systems, and more particularly, relates to tube connection systems with a cross-linked PEX retention sleeve device.

### BACKGROUND OF THE INVENTION

Elastomeric tube connections are commonly utilized for fluid connections in the life science and medical research industries, such as the biopharmaceutical industry. Typically, an elastomeric tube, such as a rubber or silicon hose, is disposed between a pair of fluid connectors which have barbed male ends. While these elastomeric tubes are capable of being stretched over the barbed male ends, they generally cannot be connected in this manner by themselves and are an area of critical failure. Any minute pressurized fluid flow, such as an elevated pressure encountered during pumping operations, would eventually cause ballooning of the tube around the barb, leading to fluid leakage or allowing the ingress of foreign organisms.

Typically, a hose clamp or one or more plastic cable ties are wrapped around the ends of the elastomeric tube where the barbed male end of the connector has been inserted, in order reinforce and secure the elastomeric tube. One problem associated with these clamps and ties are that mechanically, the hoop forces applied by the clamp or cable tie is nonuniform. When smaller diameter elastomeric tubes or hoses are employed, which is a high percentage in the biopharmaceutical and medical fields, both the clamps and cable ties have an uneven circumferential hoop force. For example, for a cable tie systems, a much lower hoop force is applied at the 90 degree intersection of the cable tie juncture. For secure connections, thus, two ties are often utilized with the junctions located 180 degrees apart.

To optimize performance, cable tensioning tools are required to be calibrated prior to use. This procedure is more labor intensive, and requires a skilled technician to properly complete the fluid connection.

Another problem associated with these type connections is that the clamp or cable tie is typically located behind the barb to increase the “pull of” resistance of the barb/tube connection and to assist in holding the elastomer tube against the raised edge of the barb to maintain a seal. At elevated internal pressure, the elastomer tubing can expand away from the barb promoting leaks.

More recently, a cross-linked polyethylene, typically referred to as PEX, has been developed for tubing materials. Cross-linking improves both the elevated-temperature properties, as well as the low temperature properties, of the base polymer. Cross-linking further enhances chemical resistance of the polymer, while also improving its impact and tensile strength, scratch resistance, and resistance to brittle fracture.

Due primarily to these improved properties, PEX is now in widespread use for building services pipework systems, domestic water piping, hydronic radiant heating and cooling systems, chemical transportation, and transportation of sewage and slurries to name a few.

Another advantageous characteristic of PEX material is its memory retention properties. PEX tubing is capable of substantial radial expansion, and subsequent contraction back towards its natural unexpanded condition without damaging the structural integrity of the tubing. In limited applications, thus, PEX tubing can be used by itself to form a fluid-tight connection over the barbed male connector without the need for any additional adhesives and/or hose clamps. The use of PEX tubing alone, however, is significantly restricted due to the relative stiffness of the PEX material itself. While PEX tubing is considered flexible compared to metallic and ceramic piping, PEX material's coefficient of stiffness, k, for tubing is still very stiff compared to that for conventional elastomeric tubing.

In order to generate sufficient hoop forces to seal around a barbed male connector, given the relative stiffness of the PEX tubing material, a few companies have began using an PEX sleeve over the PEX tubing at the connector, effectively increasing the thickness of the PEX tubing which proportionately, with respect to its cross-section, increases its hoop force about the barbed connector. One company in particular, Uponor, offers PEX plumbing systems for residential and commercial plumbing applications, generating the desired uniform hoop forces about the fluid connectors.

These PEX sleeves over PEX tubing, however, are not suitable for application in the life science and medical research industries. First, the forces necessary to radially expand both the PEX sleeve and PEX tubing, simultaneously as a unit, are significant, adding to the difficulty of fabrication in a clean room environment. Furthermore, the relatively stiff PEX tubing will not operate in typical peristaltic liquid pumping applications, and is unacceptable in laboratory and manufacturing environments where space is limited. Use of such PEX tubing in smaller space laboratories is thus not feasible.

Accordingly, there is need for an elastomeric tubing system for use in the life science and medical research industries that is capable of generating substantially uniform compressive hoop forces.

### SUMMARY OF INVENTION

The present invention provides a tube connection system having a tube connector fitting, an elongated elastomeric tube device and a cross-linked PEX tubular retention device. The tube connector fitting includes a barbed male portion having a longitudinal length and a communication port at the end thereof. The elongated elastomeric tube device includes a distal portion defining a circumferential exterior wall having an exterior diameter, as well as a circumferential interior wall that defines a fluid channel extending longitudinally therethrough. This fluid channel terminates at a distal port of the distal portion thereof, and is of an interior diameter sized and dimensioned for slideable, press-fit receipt of the longitudinal length of the fitting barbed male portion, through the distal port and into the fluid channel, fluidly communicating the tube device distal port with the fitting communication port.

As mentioned, the present tube connection system further includes an elongated tubular retention sleeve, composed of a cross-linked PEX material having shape memory properties, which is disposed around the distal portion of the tube device. The retention sleeve includes an inner wall which defines a receiving channel therethrough, and which is sized for snug sliding receipt of the tube device therein, in an unexpanded natural condition. In this natural condition, the retention sleeve has an unexpanded inner diameter in the range of about 5% to about 40% smaller than the exterior diameter of the tube device exterior wall. The retention sleeve, as mentioned, is composed of a cross-linked PEX material having memory retention properties such that when the retention sleeve is radially expanded from the unexpanded natural condition to an expanded condition, the retention sleeve will slowly retract back towards its natural condition once the forces retaining the sleeve in the expanded condition are removed.

In accordance with the present invention, however, in the expanded condition, the retention sleeve is radially expanded about 15% to about 50% greater than the unexpanded inner diameter. Subsequently, the expanded sleeve is placed or disposed about the tube device, and the distal portion of the tube device is the press-fit onto the barbed male portion of the connector fitting. With the expansion forces removed, the expanded retention sleeve can be allowed to retract back toward the natural condition. The retracted cylindrical retention sleeve generates significant, radially uniform, hoop forces around the tube distal portion for fluid tight mounting to the connector fitting.

In one specific embodiment, the retention sleeve includes a capture feature extending radially inward from the sleeve inner wall. This capture feature is configured to facilitate stable positioning of the retention sleeve relative to the tube device as the sleeve retracts from the expanded condition toward the natural condition.

In another configuration, the capture feature is in the form of an annular prong configured to grip the elastomeric tube device during sleeve retraction. This annular prong can extend extending continuously around the inner wall.

Yet another embodiment provides a capture feature which is positioned proximate to a distal end the sleeve receiving channel.

Another specific configuration provides an inner diameter of the retention sleeve, in the unexpanded natural condition, is about 10% smaller than the exterior diameter of the tube device exterior wall.

Still another embodiment provides that the retention sleeve which is radially expanded in the range of about 20% to about 30% greater than the unexpanded inner diameter of the retention sleeve, and more preferably is in about 25%.

In another aspect of the present invention, a method is disclosed for forming a fluid-tight connection between a tube device to a tube connector fitting in a biopharmaceutical clean-room environment. The method includes providing an elastomeric tube device having a distal portion defined by a circumferential exterior wall and having an exterior diameter. The tube device distal portion also includes a circumferential interior wall further defining a fluid channel extending longitudinally therethrough and terminating at a distal port of the distal portion thereof. The method also includes providing an elongated tubular retention sleeve composed of a cross-linked PEX material having memory retention properties. The retention sleeve includes a circumferential inner wall defining a receiving channel extending therethrough, and having an unexpanded inner diameter, in an unexpanded natural condition. This inner diameter is in the range of about 5% to about 40% smaller than the exterior diameter of the tube device exterior wall.

In accordance with the present invention, the method includes radially expanding the elongated tubular retention sleeve from the unexpanded natural condition to and an expanded condition by a sufficient amount to enable sliding receipt of the distal portion of the tube device into the receiving channel of the sleeve. The method then includes inserting the distal portion of the tube device onto a barbed male portion of the connector fitting along a longitudinal length thereof. The circumferential interior wall of the tube device includes an interior diameter sized and dimensioned for slideable, press-fit receipt of the longitudinal length of the fitting barbed male portion therein. Finally, the method provides permitting radial retraction of the radially expanded retention sleeve around the tube distal portion from the expanded condition back toward the natural condition, generating significant, radially uniform, hoop forces around the tube distal portion for fluid tight mounting to the connector fitting.

In one specific embodiment, the method includes radially expanding the retention sleeve from the unexpanded condition to the expanded condition in the range of about 15% to about 50% from the unexpanded inner diameter.

In another configuration, radially expanding of the retention sleeve from the unexpanded condition to the expanded condition is performed by positioning a distal end of a tapered mandrel through the receiving channel of the retention sleeve. The tapered mandrel of which include at least a tapered portion tapering radially outward from the distal end thereof toward a proximal portion thereof. Further, the method includes forcing the retention sleeve proximally about the mandrel until the sufficient amount of radial expansion is attained.

The method further includes either increasing the hoop forces by selecting a retention sleeve with a larger wall thickness from a circumferential outer wall to the circumferential inner wall thereof, in the unexpanded condition, or decreasing the hoop forces by selecting a retention sleeve with a smaller wall thickness from the circumferential outer wall to the circumferential inner wall thereof, in the unexpanded condition.

Still another embodiment includes reducing longitudinal drift of the retention sleeve, relative to the elastomeric tube device, during retraction of the radially expanded retention sleeve from the expanded condition back toward the natural condition by incorporating a capture feature extending radially inward from the sleeve inner wall.

### BRIEF DESCRIPTION OF THE DRAWINGS

The assembly of the present invention has other objects and features of advantage which will be more readily apparent from the following description of the best mode of carrying out the invention and the appended claims, when taken in conjunction with the accompanying drawing, in which:

FIG. 1 is a side perspective view of a tube connection system constructed in accordance with the present invention.

FIG. 2 is a side perspective view of the tube connection system of FIG. 1 having a connector fitting with a dual barbed male ends.

FIG. 3 is an exploded, side elevation view, in cross-section, of the tube connection system of FIG. 1, showing the cross-linked PEX retention sleeve in an unexpanded natural condition.

FIG. 4 is an exploded, top perspective view of the tube connection system of FIG. 1, showing the cross-linked PEX retention sleeve in an expanded condition.

FIG. 5 is a bottom perspective view of the tube connection system of FIG. 1, showing the expanded retention sleeve mounted to the elastomeric tubing.

FIG. 6 is a side perspective view of the tube connection system of FIG. 1 in an upright position, showing the cross-linked PEX retention sleeve in an expanded condition.

FIG. 7 is a side elevation view, in cross-section, of the tube connection system of FIG. 1 in an upright position, showing the cross-linked PEX retention sleeve in an expanded condition.

FIG. 8 is a side elevation view, in cross-section, of the tube connection system of FIG. 1 in an upright position, showing the cross-linked PEX retention sleeve in a final retraction rest condition.

FIG. 9 is an enlarged, top perspective view, in cross-section, of the cross-linked PEX retention sleeve of tube connection system of FIG. 1.

FIG. 10 is a fragmentary, top perspective view, of a tube expansion assembly constructed in accordance with the present invention.

FIGS. 11A-11E is a sequence of side elevation views, in cross-section, of the tube expansion assembly of FIG. 10, illustrating an expansion of the retention sleeve.

### DETAILED DESCRIPTION OF THE INVENTION

While the present invention will be described with reference to a few specific embodiments, the description is illustrative of the invention and is not to be construed as limiting the invention. Various modifications to the present invention can be made to the preferred embodiments by those skilled in the art without departing from the true spirit and scope of the invention as defined by the appended claims. It will be noted here that for a better understanding, like components are designated by like reference numerals throughout the various figures.

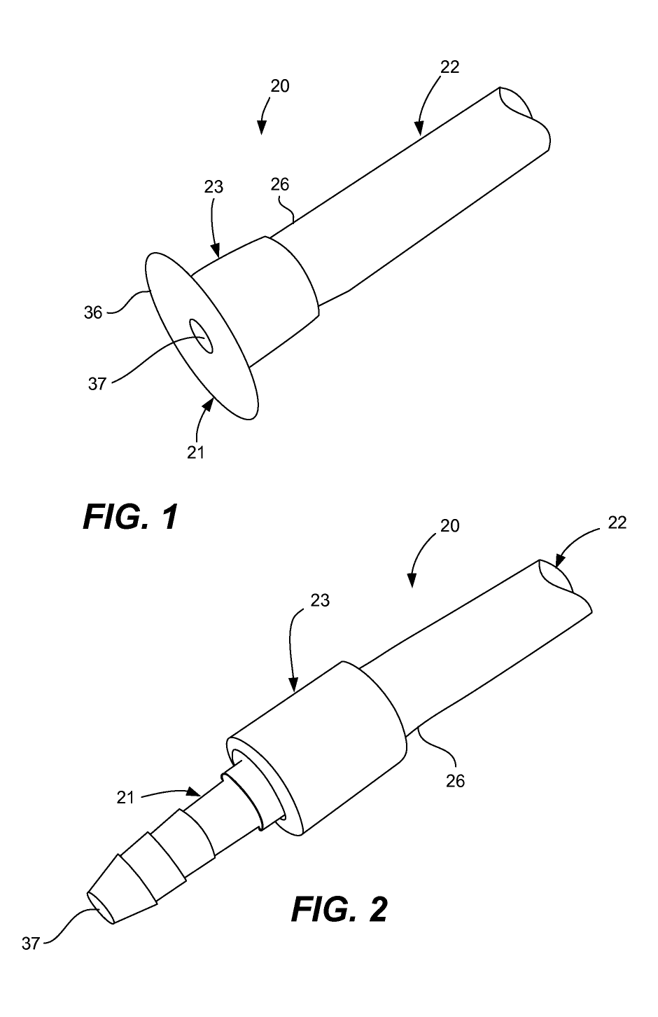

Referring now to FIGS. 1-8, a tube connection system, generally designated 20, is shown generally having a tube connector fitting 21, an elongated elastomeric tube device 22 (transfer tubing) and a cross-linked PEX tubular retention sleeve 23. The tube connector fitting 21 includes a barbed male portion 24 having a longitudinal length and a communication port 25 at the end thereof. The elongated elastomeric tube device 22 includes a distal portion 26 defined by a circumferential exterior wall 27 having an exterior diameter, D₁. The tube device further includes a circumferential interior wall 28 that defines a fluid channel 29 extending longitudinally therethrough. This fluid channel 29 terminates at a distal port 30 of the distal portion 26 thereof, and is of an interior diameter, D₂, which is sized and dimensioned for slideable, press-fit receipt of the longitudinal length of the barbed male portion 24 of the connector fitting 21. Such press-fit receipt is through the distal port 30 of the elastomeric tube device 22 and into the fluid channel 29, fluidly communicating the fluid channel 29 with the fitting communication port 25.

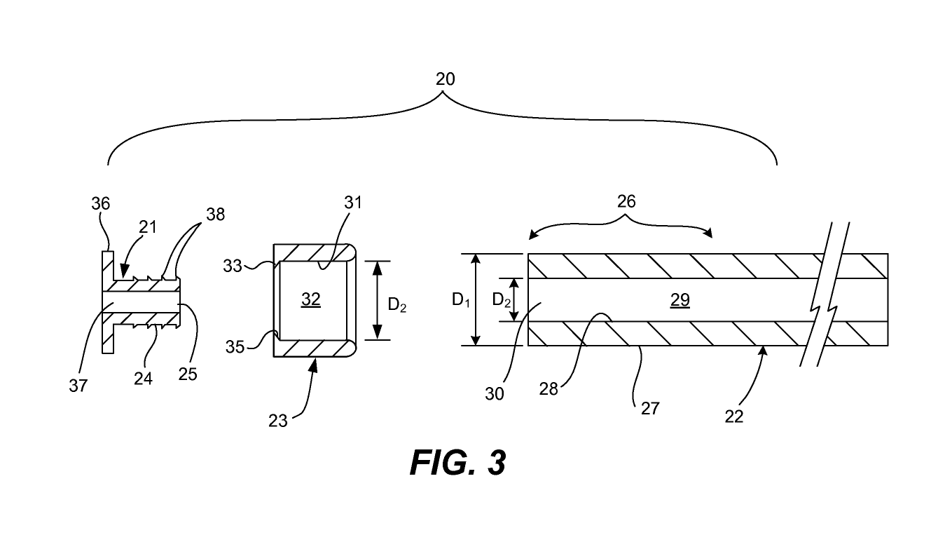

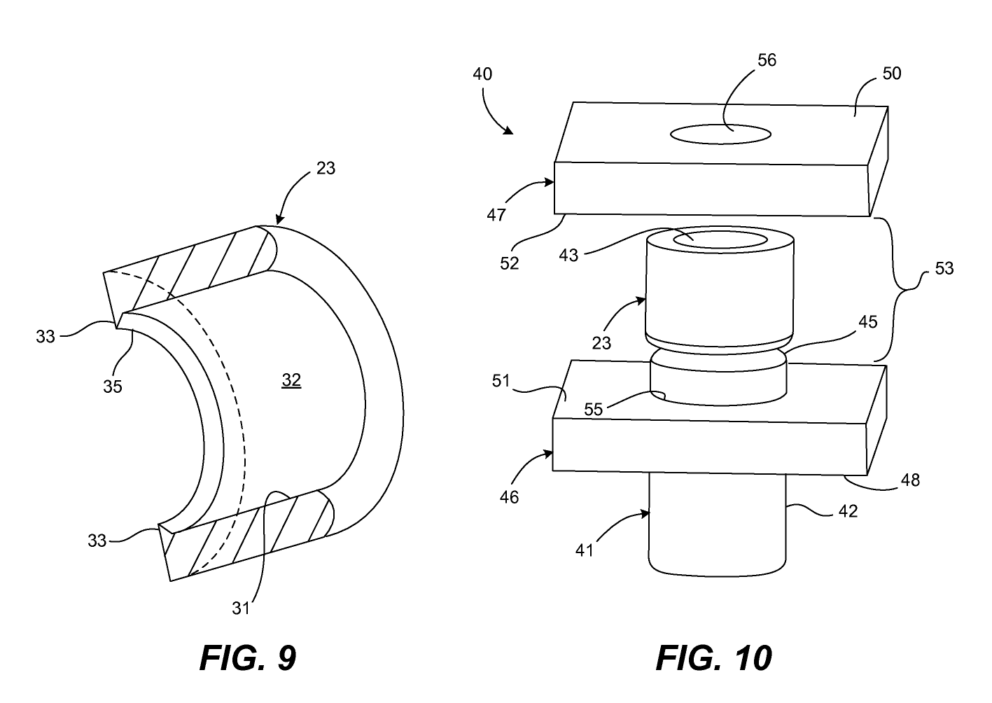

In accordance with the present invention, as mentioned, the tube connection system 20 includes an elongated tubular retention sleeve 23 which is composed of a cross-linked PEX material, providing memory retention properties, once radially expanded. FIG. 9 best illustrates that the retention sleeve 23 includes an inner wall 31 which defines a receiving channel 32 sized and dimensioned, in an unexpanded natural condition, for snug sliding receipt of the distal portion 26 of the elastomeric tube device 22 therein. In this unexpanded natural condition (FIGS. 3, 10 and 11B), the retention sleeve 23 has an unexpanded inner diameter, D₃, that is selected to be in the range of about 5% to about 40% smaller than the exterior diameter, D₁, of the tube device exterior wall 27.

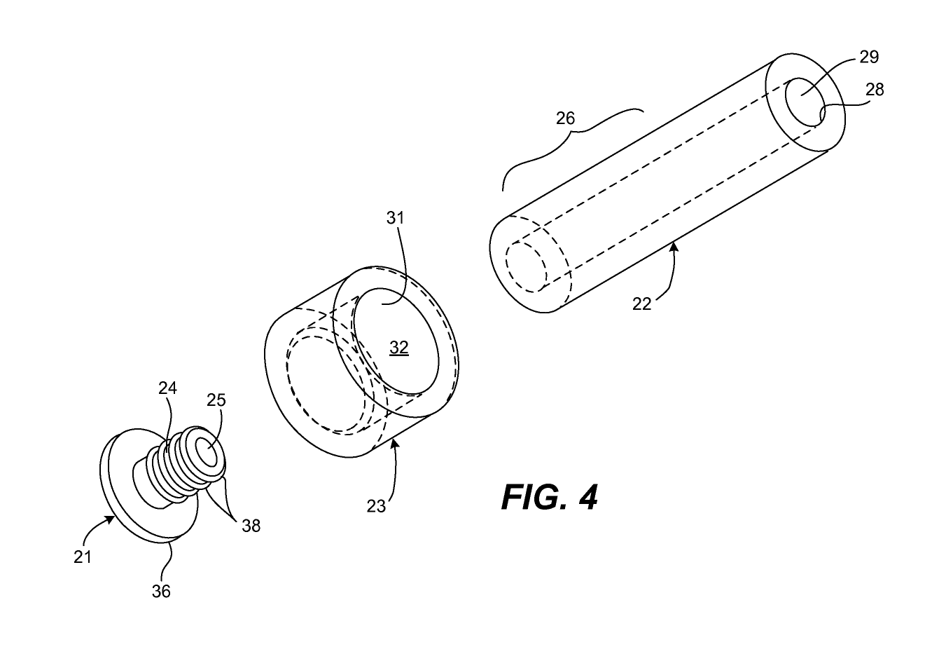

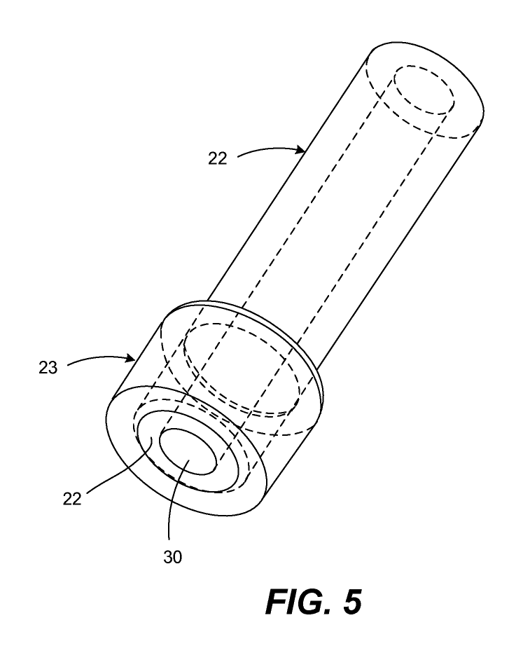

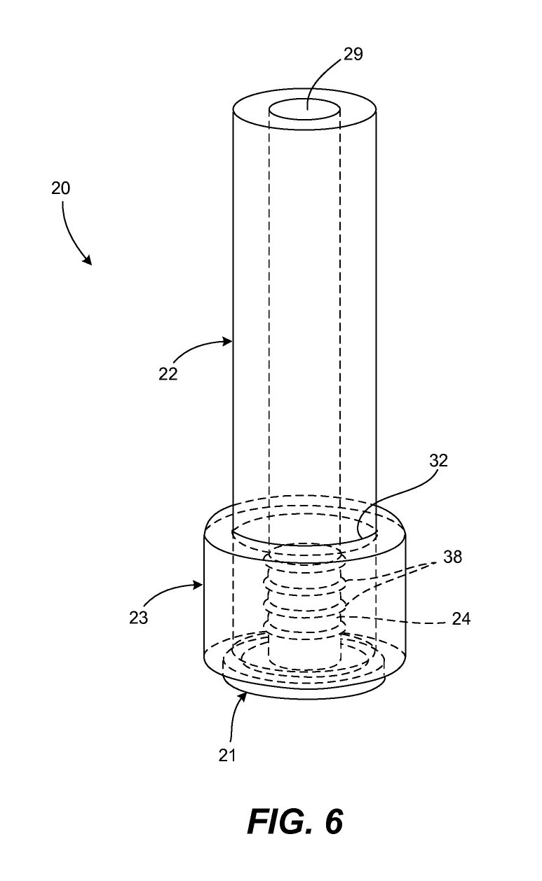

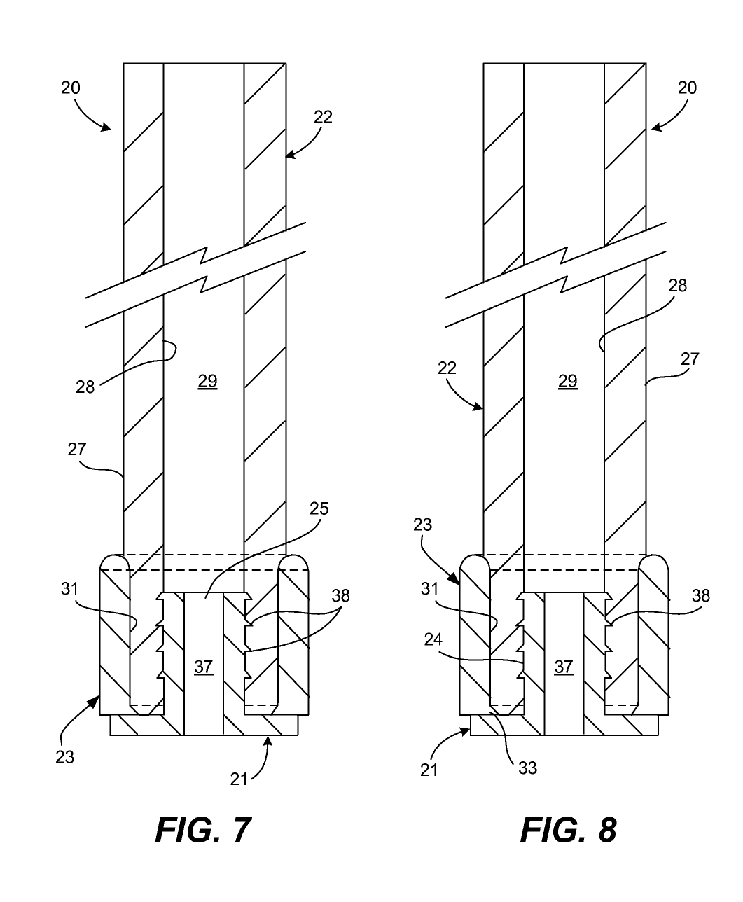

To fit the cross-linked PEX retention sleeve 23 over the distal portion 26 of the elastomeric tube device, however, the retention sleeve 23 is radially expanded, in the range of about 15% to about 50% from the unexpanded inner diameter, D₃, to an expanded condition (FIG. 4), and then placed about the distal portion of the tube device (FIG. 5). Subsequently, the distal portion 26 of the tube device 22, together with the radially expanded retention sleeve 23, can be slideably press-fit onto the barbed male portion 24 of the connector fitting 21 (FIGS. 6 and 7). Subsequently, the expanded retention sleeve 23 can be allowed to retract back toward the natural condition to a final retraction rest condition (having a rest diameter greater than the unexpanded inner diameter, D₃, but less than that in the expanded condition) (FIGS. 1, 2 and 8). The retention sleeve 23 generates significant, circumferentially uniform, hoop forces around the tube distal portion 26 for fluid tight mounting of the tube device 22 to the connector fitting 21.

Accordingly, a tube connection system is provided that combines a cross-linked PEX retention sleeve, having memory retention properties, with a conventional elastomeric tube device for fluid-tight connection to a conventional tube connector fitting. This is advantageous, especially when the present invention is employed in a biopharmaceutical/medical clean room environment where suitable tubing components, and assembly thereof, are more limited. As mentioned, due to the space limitation, very flexible, small diameter, tubing is desired to facilitate and simplify the fluid connections between the tubes or hoses and the connector fittings for fluid reservoirs, such as cell culture media containers, bioreactors, parental feeding tube sets and chemotherapy delivery and dialysis therapy tube sets. Moreover, unlike the current hose clamp and nylon cable tie designs that are used in combination with elastomeric tubing, compression flat spots are eliminated since the cylindrical retention sleeves are capable of imparting circumferentially uniform hoop forces all around the tube device.

In accordance with the present invention, the tube device 22 employed can be any conventional elastomeric hose material typically used for biopharmaceutical, medical and surgical and industrial applications that exhibit resistance to chemicals, fluctuations in temperature, and abrasion; are of high purity; and have long service life properties. Such general purpose flexible fluid transfer tubing is generally composed of natural and synthetic elastomers such as Silicone tubing, Tygon tubing, Viton tubing, PTFE tubing. General examples of these can be found on www.coleparmer.com, for instance.

As best shown in FIGS. 3 and 4, the tube device 22 has an elongated, cylindrical-shaped body having a generally uniform, cylindrical exterior wall 27, as well as a generally uniform, cylindrical interior wall 28. In other words, the exterior diameter and the interior diameter are preferably, although not necessarily, uniform from the distal portion 26 of the tube device to an opposite end thereof.

Moreover, while the present invention is applicable to a wide range of OD/ID elastomeric tubing, given the resilience and compressibility properties of these elastomeric materials, it is not desirable to have a wall thickness that is greater than the tubing interior diameter, D₂. In one specific example, the tubing wall thickness is in the range of about 1 mm to about 3 mm.

With respect to the PEX retention sleeve 23, as mentioned, one advantageous property of a tubular form of PEX material is its ability to radially retract from an expanded condition back toward its unexpanded natural condition, generating significant hoop forces uniformly around the circumference of the tubing exterior wall 27. Such radial force uniformity is important, especially when the ID of the elastomeric tubing is small, on the order of about 1 mm to about 12 mm. As mentioned, when hose clamps and/or plastic cable ties are used in combination with elastomeric tubing, compression flat spots are often formed which are prone to eventual leakage or failure thereat.

The disposal of the PEX retention sleeve 23 around the elastomeric tube device 22, in accordance with the present invention, provides a uniform hoop force circumferentially around the exterior wall 27 of the distal portion of the tube device. This promotes a uniform circumferential seal around the connector fitting that is simple to attached, and requires little performance skills. Such uniformity may be exhibited even should the circumference not be perfectly circular.

Depending upon the wall thickness, the retention sleeve 23 has been observed to be capable of radially expanding, from its natural condition, more than 100% from the unexpanded inner diameter, D₃, to the expanded condition, and then observed to retract back to it natural condition inner diameter. Such expansion, however, may potentially permanently deform the sleeve and/or cause fracture thereof. The preferred range of expansion, thus, is about 15% to about 50% from the unexpanded inner diameter, D₃. More preferably, the range of expansion is about 20% to about 30% from the unexpanded inner diameter, D₃, and most preferably about 25%.

Another observation is that PEX retention sleeves 23 of the same unexpanded inner diameter, D₃, and of the same wall thickness will impart generally the same collective hoop forces at the same final retraction rest condition diameter, regardless of the initial degree of expansion. Moreover, the collective hoop forces are proportional to the final retraction rest condition diameter as well. This is advantageous in that the desired hoop forces can be preselected based on the selection of the retention sleeve 23, and the estimated final retraction rest condition diameter.

In another example, the hoop forces generated by a retention sleeve that is initial expanded to an expansion diameter 35% greater than unexpanded inner diameter, D₃, and then allowed to retracts around a first tube device to a final retraction rest condition diameter that is around 25% greater than the unexpanded inner diameter, D₃, will be greater than if an identical retention sleeve were initial expanded to an expansion diameter 40% greater than the unexpanded inner diameter, D₃, and then allowed to retracts around a second (smaller diameter) tube device to a final retraction rest condition diameter that is around 15% greater than the unexpanded inner diameter, D₃.

Another technique to increase or decrease the collective hoop forces is to select a retention sleeve with an increased or decreased wall thickness. Increasing the wall thickness generates greater hoop forces, while decreasing the wall thickness generates smaller hoop forces.

As an example, for an elastomeric tube 22 having an exterior diameter, D₁, of 6 mm and an interior diameter, D₂, of 3 mm (i.e., a wall thickness of 1.5 mm), a PEX retention sleeve 23 might be selected having an unexpanded inner diameter, D₃, in the range of about 4.6 mm to about 5 mm, and a wall thickness in the range of about 1.5 mm to about 2.0 mm. For such tube device an range of retention sleeve selections, the final retraction rest condition diameter generally be in the range of around 20% to around 30% greater than the unexpanded inner diameter, D₃.

Thus, the hoop forces of a PEX retention sleeve 23 are substantially uniform and established during the design and manufacture of the part. This substantially simplifies assembly and tube connections since little skill and no calibration is required to ensure a uniform tube connection.

The PEX retention sleeve 23, of course, generates the hoop forces radially upon the exterior walls 27 of the tube device. Hence, it is required that the unexpanded inner diameter, D₃, in unexpanded natural condition, be smaller than the tubing exterior diameter, D₁, if any compressive forces are to be impart. Preferably, the retention sleeve 23 is selected to have an unexpanded inner diameter, D₃, in the range of at least about 5% smaller than the exterior diameter, D₁, of the tube device exterior wall 27, and no more than about 40% smaller. More preferably, this range is about 10% smaller to about 15% smaller.

The retraction time of the expanded PEX retention sleeve 23 from the expanded condition back toward the natural condition, and to its final retraction rest condition diameter around the tube device 22 is relatively slow, regardless of the degree of initial expansion. For instance retraction times, which is generally proportional to the amount of expansion, can range from 0.5 minutes to 2.0 minutes. As will be described, this allows ample time to expand the retention sleeve, place it over the distal portion 26 of the tube device 22, and subsequently press-fit the tube device and retention sleeve combination onto the barbed male portion 24 of the tube connector fitting 21. The tube connection system 20 could then be left to complete the fluid tight formation on its own as the retention sleeve self retracts.

In fact, since the retraction time is relatively slow, the retention sleeve 23 has been observed to creep longitudinally along the elastomeric tube device 22 during tube retraction. Accordingly, in one specific embodiment as shown in FIGS. 3 and 7-9, the retention sleeve 23 includes a capture feature 33 extending radially inward from the sleeve inner wall 31 which is configured to facilitate positioning stability of the retention sleeve 23 relative to the tube device 22 as the sleeve retracts from the expanded condition toward the unexpanded natural condition.

This capture feature 33 could be in the form of a single or multiple tang or prong-like projections extending into the sleeve receiving channel 32 from the inner wall 31. For instance, the capture feature 33 could be provided by three equally spaced prongs positioned about 120° apart (not shown).

FIGS. 3 and 9 best illustrate one particular embodiment of the capture feature 33 which is preferably in the form of a continuous annular prong extending circumferentially around the inner wall, and further extending radially into the receiving channel 32. The apex portion 35 of the capture feature/prong 33 need not be particularly sharp or be particularly deep, as long as there is a slight interference fit with the exterior wall 27 of the tube device. Preferably the height of the annular prong from the inner wall 31 to the apex portion 35 is in the range of about 10% to about 25% of the unexpanded inner diameter, D₃.

In the expanded condition, it is preferable to configure the annular prong 33 such that the apex portion 35 thereof has a slight interference fit with the exterior wall 27 of the tube device. However, even if the retention sleeve 23 is overly expanded, the capture feature/annular prong 33 will be the first portion of the expanded retention sleeve 23 to contact and interference fit with the exterior wall 27 of the elastomeric tube device 22 during retraction. As the apex portion 35 begins contact with the exterior wall 27 of the elastomeric tube device 22, the longitudinal creep is significantly reduced as the remaining portions of the sleeve slowly retract and radially compress the tube device.

The capture feature 33 can be longitudinally position anywhere along the inner wall 31 of the retention sleeve 23. Preferably, however, the capture feature 33 is positioned proximate to a distal end the sleeve receiving channel 32, as shown in FIG. 9. This distal positioning simplifies assembly when the expanded retention sleeve 23 is placed over the elastomeric tube device since the interfering contact does not occur until the sleeve is nearly fully placed onto the tube. Moreover, the capture feature 33 at this distal position may even function as a stop feature of sorts.

Finally, the PEX retention sleeve 23 can be fabricated through molding or extrusion. The advantage of molding the retention sleeve is that the capture feature can be easily molded right into the inner wall 31. For an extruded retention sleeve, by comparison, such a capture feature would require additional machining or the like. Moreover, for a molded sleeve, rounded edges can be easily molded right into the sleeves (FIGS. 3 and 9), removing any sharp edges that can potentially cause failure of the fragile thin plastic reservoir bags during assembly and disassembly, shipping and side-to-side motion of the fluid connections experienced during operation. Again, for an extruded retention sleeve 23, such rounded edges may require additional machining.

Referring now to FIGS. 3 and 4, the connector fitting 21 is shown having a plate like backing 36 with the conventional barbed male portion 24 protruding outwardly therefrom. A communication channel 37 extends through the backing 36, and along the longitudinal length of the barbed male portion 24 terminating at the communication port 25. A distal side of the backing 36 could be fluidly coupled to any fluid reservoir (e.g., a bottle or bag), or have another barbed male portion (FIG. 2) or a female connector end.

While the barbed male portion 24 is shown with four barbs 38, the present invention can be utilized with a connector fitting only having a single circumferential barb 38. Regardless, in accordance with the present invention, the retention sleeve 23 is longitudinal sized and designed to be longitudinal position, relative to the barbed male portion 24, to axially extend both proximally and distally beyond at least one of the annular barbs. As best shown in FIG. 8, when the retention sleeve 23 is in the final retraction condition, radially compressing the elastomeric tube device, the sleeve positioning and length ensure the interior wall 28 of the elastomeric tube device 22 will be in abutting contact with the exterior surface of the barbed male portion 24 of the connector fitting. In this manner, since the hoop forces are substantially uniform circumferentially around the distal portion 26 of the tube device 22, and thus, the barbed male portion 24, the elastomeric tube device 22 is captured and inhibited from expanding away from the annular barb under pressure.

To ensure such capture, the longitudinal length of the retention sleeve 23 is preferably at least about one half of the longitudinal length of the barbed male portion 24, and more preferably longer than the barbed male portion. The latter option absolutely ensuring that the retention sleeve extends both distally and proximally beyond at least one of the annular barbs 38.

Referring now to FIGS. 4-8, one particular technique and/or procedure for preparing and assembling the PEX retention sleeve 23 and elastomeric tube device 22 will be shown and described. As previously mentioned, the correctly sized connector fitting 21, elastomeric tube device 22 and retention sleeve 23 must be selected within the appropriate diametric ranges are desired hoop forces. Briefly, the tubing interior diameter, D₂, must be sized and dimensioned for slideable, press-fit receipt of the longitudinal length of the fitting barbed male portion 24, through the distal port 30 and into the fluid channel 29. Since the tube device material is elastomeric, the tube walls can be easily stretched over the annular barbs 38 of the barbed male portion 24 of the connector fitting 21. It will be appreciated, however, that due to the uniform, compressive hoop forces distributed radially about the distal portion 26 of the tube device, the tubing interior diameter, D₂, when not expanded, could be even slightly larger than the diameter to the annular barbs 38. This may not preferably, however.

Also briefly, with respect to the selection of the retention sleeve, both the inner diameter, D₃, of the retention sleeve 23 must be selected within the appropriate range (relative to the exterior diameter, D₁, of the tube device 22), as well as the wall thickness of the sleeve which corresponds to the desired compressive hoop forces. As set forth above, the unexpanded inner diameter, D₃, of the retention sleeve 23 preferably is in the range of about 5% to about 40% smaller than the exterior diameter, D₁, of the tube device exterior wall 27.

To expand the retention sleeve 23 from its natural unexpanded condition (FIG. 3) to an expanded condition (FIG. 4), this procedure can be performed using any many conventional expansion techniques. For example, a specific expansion tool could be used having jaws that spread the sleeve radially outward, such as the M12™ ProPEX expansion tool provided by Uponor EP/Milwaukee. Another technique could be employing a gradually tapered ring-style mandrel (not shown) where the retention sleeve is forced up the tapered mandrel, slowly expanding the inner diameter, D₃, to the desired amount. Moreover, the application of a gradually tapered mandrel is that by providing a proximal opening into the receiving channel 32 that is slightly greater than the distal opening, at the opposite opening thereof, the expanded retention sleeve 23 may be more easily initially positioned onto the tube device 22.

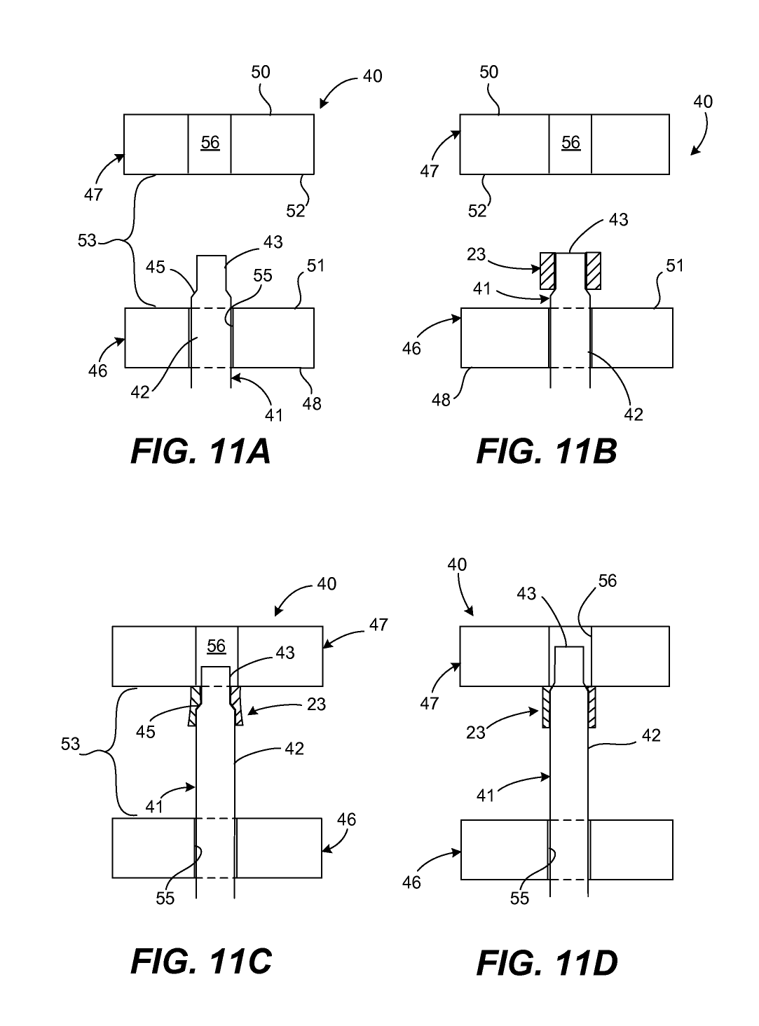

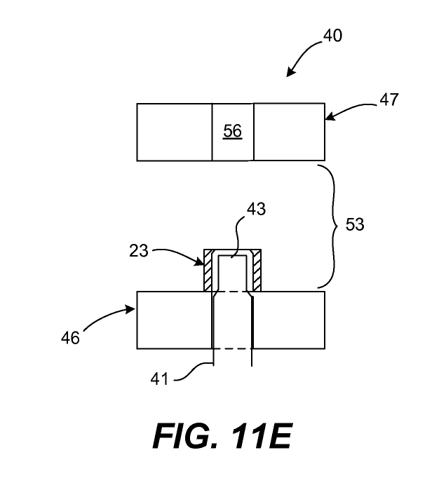

In one particular technique, a specific retention sleeve expansion assembly 40 is employed (FIG. 10). As shown in the sequence of FIGS. 11A-11E, a reciprocating mandrel 41 is provided having a primary shaft portion 42 and a distal nipple end 43 diametrically sized and dimensioned for sliding receipt of the PEX retention sleeve 23 in the unexpanded natural condition. Essentially, the nipple end diameter is substantially similar to the sleeve unexpanded inner diameter, D₃.

With respect to the diametric size of the primary shaft portion 42, this dimension is based upon the desired expansion diameter of the retention sleeve 23, in the expanded condition. A conical taper portion 45 couples the smaller diameter nipple end 43 to the larger diameter primary shaft portion 42, facilitating mechanical expansion of the retention sleeve 23 from the unexpanded natural condition to the expanded condition.

In accordance with this aspect of the present invention, the sleeve expansion assembly 40 further includes a pair spaced first and second alignment plates 46, 47 disposed substantially parallel to one another. Each plate 46, 47 includes a respective outer wall 48, 50 and a respective inner wall 51, 52, the opposed inner walls of which define an access space 53 therebetween. Briefly, it will be appreciated that the opposed inner walls 51, 52 are sufficiently spaced to enable loading and unloading of the retention sleeve as will be described.

The first alignment plate 46 defines a first receiving passage 55 extending therethrough from the respective outer wall 48 to the respective inner wall 51 thereof. This receiving passage 55 is sized and dimensioned for smooth sliding axial receipt of the primary shaft portion 42 axially therethrough as it reciprocates between a load position (FIGS. 11A and 11B), an expansion position (FIG. 11D), and a strip position (FIG. 11E). In order to remove the expanded retention sleeve 23 from the primary shaft portion 42, the diameter of the first receiving passage must be less than the outer diameter of the expanded retention sleeve 23 (FIGS. 11D and 11E).

As shown in FIGS. 10 and 11A, the second alignment plate 47 also defines a second receiving passage 56, co-axially aligned with the first receiving passage 55 of the first alignment plate. The second receiving passage 56, however, is sized and dimensioned for sliding reciprocal receipt of the nipple end 43 axially therethrough. In one embodiment, the second receiving passage is size to only permit passage of the nipple end 43, while preventing the passage of the primary shaft portion 42 (FIG. 10). In another embodiment, the second receiving passage 56 can be sized to permit passage of the primary shaft portion 42 therethrough. In the latter example, such a design would be permit the use of a gradually outwardly tapered primary shaft portion.

To initiate expansion of the unexpanded retention sleeve 23, the mandrel 41 is retracted in a direction toward the first receiving passage 55 to a load position (FIGS. 11A and 11B). This position orients the mandrel 41 in a manner such that the nipple end 43 is sufficiently accessible within the access space 53 to place the retention sleeve 23 thereon. Once the sleeve is press-fit secured onto the nipple end (FIG. 11B), the mandrel 41 can be moved axially toward the second receiving passage 56 of the second alignment plate (FIG. 11C). As the mandrel nipple end 43 is slideably received in the second receiving passage, the distal end of the retention sleeve 23 abuts against the inner wall 52 of the second alignment plate 47, preventing further axial displacement of the sleeve (FIG. 11C).

Subsequently, as shown in FIG. 11D, as the mandrel nipple end is moved further axially into the second receiving passage 56, to the expansion position, the sleeve is forcibly pushed up the conical tapered portion 45, where the radial expansion to the expanded condition is caused until the expanded retention sleeve is retained around the primary shaft portion 42.

To remove the expanded retention sleeve 23 from the mandrel 41, the mandrel is merely retracted axially back toward the first alignment plate 46, pulling both the primary shaft portion 42 and at least the tapered conical portion 45 into first receiving passage 55, to the strip position (FIG. 11C). The expanded retention sleeve 23 will displace rearwardly until a proximal end of the retention sleeve abuts against the inner wall 51 of the first alignment plate 46. Since the first receiving passage 55 is only diametrically sized for reciprocal receipt of the mandrel, the expanded retention sleeve 23 will be stripped off of the mandrel in the expanded condition.

Once the expanded retention sleeve 23 is removed from the expansion assembly 40, the slow retracting PEX material provides ample time to insert the distal portion 26 of the elastomeric tube device 22 slideable into the expanded receiving channel 32. As mentioned, a capture feature 33 can be included to provide a slight interference fit. Further, as mentioned, should the capture feature 33 be positioned at the distal end of the receiving channel 32, the annular prong 33 can function as a stop feature as well.

Since the shape memory properties of the expanded PEX retention sleeve 23 are relatively slow to retract back toward the natural condition, the concentrically positioned retention sleeve, in the expanded condition, and elastomeric tube device 22 can be easily press-fit onto the barbed male portion 24 of the connector fitting 21. Subsequently, the expanded sleeve can be left alone to retract slowly, radially compressing the tube fitting and imparting circumferentially uniform hoop forces to mount to the connector fitting 21 with no calibration and little skill provided by the technician.

Although only a few embodiments of the present inventions have been described in detail, it should be understood that the present inventions might be embodied in many other specific forms without departing from the spirit or scope of the inventions.

What is claimed is:

1. A tube connection assembly for use with a tube connector fitting having a barbed male portion with a communication port, the barbed male portion having an outer barb diameter and a longitudinal length, the tube connection assembly comprising:
an elongated elastomeric tube device having a distal portion defining a circumferential exterior wall and a circumferential interior wall, the interior wall further defining a fluid channel extending longitudinally therethrough and terminating at a distal port of the distal portion thereof, the circumferential exterior wall having an exterior diameter and the circumferential interior wall having an interior diameter sized and dimensioned for slideable, press-fit receipt of the longitudinal length of the fitting barbed male portion, through the distal port and into the fluid channel, fluidly communicating the tube device fluid channel with the fitting communication port; and
an elongated tubular retention sleeve disposed around the distal portion of the having an inner wall defining a receiving channel therethrough with an unexpanded inner diameter, in an unexpanded natural condition, in the range of about 5% to about 40% smaller than the exterior diameter of the tube device exterior wall, the retention sleeve being composed of a cross-linked PEX material having memory retention properties such that when the retention sleeve is radially expanded from the natural condition, in the range of about 15% to about 50% greater than the unexpanded inner diameter, to an expanded condition, the sleeve will radially retract back toward the natural condition, to generate significant, radially uniform hoop forces around the tube distal portion for fluid tight mounting to the connector fitting.

2. The tube connection assembly according to claim 1, wherein
the retention sleeve is distally disposed generally at a distal end of the tube distal portion output and extends proximally a length of at least half of the longitudinal length of barbed male portion of the connector fitting.

3. The tube connection assembly according to claim 2, wherein
the retention sleeve includes a capture feature extending radially inward from the sleeve inner wall, and configured to facilitate stable positioning of the retention sleeve relative to the tube device as the sleeve retracts from the expanded condition toward the natural condition.

4. The tube connection assembly according to claim 3, wherein
the capture feature includes an annular retention barb extending circumferentially around the inner wall.

5. The tube connection assembly according to claim 4, wherein
the annular retention barb extends continuously around the inner wall.

6. The tube connection assembly according to claim 4, wherein
the capture feature is positioned proximate to a distal end the sleeve receiving channel.

7. The tube connection assembly according to claim 4, wherein
the annular retention barb extends radially inward with a height in the range of about 10% to about 25% of the inner diameter thereof.

8. The tube connection assembly according to claim 1, wherein
the sleeve inner diameter, in the unexpanded natural condition, is in the range of about 10% smaller than the exterior diameter of the tube device exterior wall, and
the retention sleeve is radially expanded about 25% in the expanded condition.

9. A tube connection system comprising:
a tube connector fitting having a barbed male portion with a communication port, the barbed male portion having an outer barb diameter and a longitudinal length;
an elongated elastomeric tube device having a distal portion defining a circumferential exterior wall and a circumferential interior wall, the interior wall further defining a fluid channel extending longitudinally therethrough and terminating at a distal port of the distal portion thereof, the circumferential exterior wall having an exterior diameter and the circumferential interior wall having an interior diameter sized and dimensioned for slideable, press-fit receipt of the longitudinal length of the fitting barbed male portion, through the distal port and into the fluid channel, fluidly communicating the tube device fluid channel with the fitting communication port; and
an elongated tubular retention sleeve disposed around the distal portion of the having an inner wall defining a receiving channel therethrough with an unexpanded inner diameter, in an unexpanded natural condition, in the range of about 5% to about 40% smaller than the exterior diameter of the tube device exterior wall, the retention sleeve being composed of a cross-linked PEX material having memory retention properties such that when the retention sleeve is radially expanded from the natural condition, in the range of about 15% to about 50% greater than the unexpanded inner diameter, to an expanded condition, the sleeve will radially retract back toward the natural condition, to generate significant, radially uniform hoop forces around the tube distal portion for fluid tight mounting to the connector fitting.

10. The tube connection system according to claim 9, wherein
the retention sleeve includes a capture feature extending radially inward from the sleeve inner wall, and configured to facilitate stable positioning of the retention sleeve relative to the tube device as the sleeve retracts from the expanded condition toward the natural condition.

11. The tube connection system according to claim 10, wherein
the capture feature includes an annular retention barb extending continuously around the inner wall.

12. The tube connection system according to claim 11, wherein
the capture feature is positioned proximate to a distal end the sleeve receiving channel.

13. The tube connection system according to claim 9, wherein
the sleeve inner diameter, in the unexpanded natural condition, is about 10% smaller than the exterior diameter of the tube device exterior wall, and
the retention sleeve is radially expanded about 25% in the expanded condition.

14. A method for forming a fluid-tight connection between a tube device to a connector fitting in a biopharmaceutical clean-room environment comprising:
providing an elastomeric tube device having a distal portion defined by a circumferential exterior wall having an exterior diameter and a circumferential interior wall further defining a fluid channel extending longitudinally therethrough and terminating at a distal port of the distal portion thereof;
providing an elongated tubular retention sleeve having an circumferential inner wall defining a receiving channel extending therethrough and having an unexpanded inner diameter, in an unexpanded natural condition, in the range of about 5% to about 40% smaller than the exterior diameter of the tube device exterior wall, the retention sleeve being comprised of a cross-linked PEX material having memory retention properties;
radially expanding the elongated tubular retention sleeve from the unexpanded natural condition to and expanded condition by a sufficient amount to enable sliding receipt of the distal portion of the tube device into the receiving channel of the sleeve;
inserting the distal portion of the tube device onto a barbed male portion of a connector fitting along a longitudinal length thereof, the circumferential interior wall of the tube device having an interior diameter sized and dimensioned for slideable, press-fit receipt of the longitudinal length of the fitting barbed male portion therein; and
permitting radial retraction of the radially expanded retention sleeve around the tube distal portion from the expanded condition back toward the natural condition, generating significant, radially uniform hoop forces around the tube distal portion for fluid tight mounting to the connector fitting.

15. The method according to claim 14, wherein
the radially expanding of the retention sleeve from the unexpanded condition to the expanded condition is in the range of about 15% to about 50% greater than the unexpanded inner diameter.

16. The method according to claim 14, wherein
the radially expanding of the retention sleeve from the unexpanded condition to the expanded condition is performed by positioning a distal end of a mandrel through the receiving channel of the retention sleeve, the mandrel of which includes at least a tapered portion tapering radially outward from the distal end thereof toward a proximal portion thereof; and
forcing the retention sleeve proximally about the mandrel until the sufficient amount of radial expansion is attained.

17. The method according to claim 14, further including:
one of increasing the hoop forces by selecting a retention sleeve with a larger wall thickness from a circumferential outer wall to the circumferential inner wall thereof, in the unexpanded condition; and
decreasing the hoop forces by selecting a retention sleeve with a smaller wall thickness from the circumferential outer wall to the circumferential inner wall thereof, in the unexpanded condition.

18. The method according to claim 14, further including:
reducing longitudinal drift of the retention sleeve, relative to the elastomeric tube device, during retraction of the radially expanded retention sleeve from the expanded condition back toward the natural condition by incorporating a capture feature extending radially inward from the sleeve inner wall.
